(19) United States
(12) Patent Application Publication
(10) Pub. No.: US 2021/0129060 A1
(43) Pub. Date: May 6, 2021

(54) Filter medium, method for producing same and the filter medium in a filter element

(71) Applicant: MANN+HUMMEL GmbH, Ludwigsburg (DE)

(72) Inventors: Christian Zisslsberger, Grafling (DE); Christoph Krautner, Marklkofen (DE); Jens Neumann, Stuttgart (DE); Matthias Heinzmann, Bayreuth (DE); Martin Klein, Bayreuth (DE); Maximilian Bauch, Boennigheim (DE)

(21) Appl. No.: 17/090,003

(22) Filed: Nov. 5, 2020

(30) Foreign Application Priority Data
Nov. 5, 2019 (DE) 10 2019 129 776.1

(51) Int. Cl. B01D 39/16; B32B 5/02; B32B 5/26; B32B 7/12; B32B 7/02; B32B 3/26; B32B 37/12; B32B 37/18; B32B 37/02; B01D 39/18

(52) U.S. Cl. CPC B01D 39/163; B32B 2367/00; B32B 5/26; B32B 7/12; B32B 7/02; B32B 3/263; B32B 37/1284; B32B 37/182; B32B 37/02; B32B 37/1207; B01D 39/18; B01D 2239/0618; B01D 2239/0627; B01D 2239/0622; B01D 2239/0654; B01D 2239/0681; B01D 2239/0695; B01D 2239/10; B01D 2239/1291; B32B 2250/20; B32B 2037/1215; B32B 2250/24; B32B 2262/0253; B32B 2262/0261; B32B 2262/062; B32B 2262/12; B32B 2262/0284; B01D 2239/0216; B01D 2239/025; B32B 2305/20; B32B 2305/28; B32B 2307/718; B32B 2323/10; B32B 2377/00; B32B 2317/18; B32B 5/024

(57) ABSTRACT

A filter medium (1) includes a substrate layer (2) and a nanofiber layer (3), the nanofiber layer (3) being connected to the substrate layer (2) by adhesive and/or hot-melt adhesive fibers (4) which pass through the nanofiber layer. In the sequence of layers, the nanofiber layer (3) is located between the substrate layer (2) and the adhesive and/or hot-melt adhesive fibers (4). An adhesion promoter layer (6) is present between the nanofiber layer (3) and the substrate layer (2), which adhesion promoter layer comprises an adhesion promoting agent applied over the surface of the substrate layer (2), the nanofiber layer (3) being fixed to the substrate layer (2) by means of the adhesion promoter layer (6). A method for producing the filter medium (1) and a use of the filter medium (1) are also disclosed.

### TECHNICAL FIELD

The invention relates to a filter medium and a method for producing the filter medium.

### BACKGROUND

A filter medium and a method for producing same are known from WO 2018/108889 A1, the filter medium having a nanofiber layer and a substrate layer on which the nanofiber layer is arranged. The nanofiber layer is connected to the substrate layer via adhesive and/or hot-melt adhesive fibers, which are applied to the nanofiber layer thus formed after nanofibers have been deposited on the substrate layer. The adhesive and/or hot-melt adhesive fibers are made such that they pass through the nanofiber layer and establish the connection between the nanofiber layer and the substrate layer, and such that they provide a protective layer for the very sensitive nanofiber layer.

The disadvantage of this is that the processes of depositing the nanofibers on the substrate layer and applying the adhesive and/or hot-melt adhesive fibers cannot be technically separated. The process steps must be carried out consecutively, since the nanofiber layer has no connection to the substrate layer after being deposited on the substrate layer, and therefore no transport can take place, for example by rolling up or the like. This limits flexibility in the manufacturing of such a filter medium and ties up capital unnecessarily, since a system component for applying the adhesive and/or hot-melt adhesive fibers must always be procedurally downstream, directly inline, of a system component for depositing the nanofibers.

### SUMMARY OF THE INVENTIVE DISCLOSURE

The problem addressed by the present invention is therefore that of creating a filter medium that can be produced with fewer process-related restrictions.

A further problem addressed by the present invention is that of creating a production method for the filter medium that is characterized by increased flexibility in terms of time and space.

The filter medium according to the invention comprises a substrate layer and a nanofiber layer, the nanofiber layer being connected to the substrate layer by adhesive and/or hot-melt adhesive fibers which pass through the nanofiber layer. In the sequence of layers, the nanofiber layer is located between the substrate layer and the adhesive and/or hot-melt adhesive fibers. An adhesion promoter layer is present between the nanofiber layer and the substrate layer, which adhesion promoter layer comprises an adhesion promoting agent applied over the surface of the substrate layer, the nanofiber layer being fixed to the substrate layer by means of the adhesion promoter layer.

Within the context of a production process for a filter medium according to the invention, the adhesion promoter layer makes it possible, via its adhesion promoting agent, for the nanofibers to be pre-fixed after they have been deposited on the substrate layer, which is usually done in the context of an electrospinning process. The fixing of the nanofiber layer with respect to the substrate layer via the adhesion promoting agent of the adhesion promoter layer therefore advantageously has a lower adhesive strength than the connection of the nanofiber layer to the substrate layer by the adhesive and/or hot-melt adhesive fibers.

Pre-fixing prior to arranging adhesive and/or hot-melt adhesive fibers on the nanofiber layer, with the aim of connecting said nanofiber layer to the substrate layer, is not disclosed in the prior art. The pre-fixing of the nanofiber layer to the substrate layer by means of the adhesion promoting agent of the adhesion promoter layer, which pre-fixing is essential to the invention, is advantageous in that, during production of the filter medium, the process step of depositing the nanofibers on the substrate layer and the process step of arranging the adhesive and/or hot-melt adhesive fibers on the nanofiber layer can be spatially and/or temporally separated. This has clear advantages when organizing the production facilities, since fewer production process-related restrictions have to be observed. As a result, the filter medium can be produced more cost-effectively than in the prior art.

According to the invention, the adhesive and/or hot-melt adhesive fibers are applied to the nanofiber layer from the side opposite the substrate layer, so that a type of framing of the nanofiber layer is produced.

The hot-melt adhesive fibers arranged on the surface of the nanofiber layer in the context of the present invention form effective protection, e.g. as grip protection, i.e. as protection against abrasion of the nanofibers, as a result of the hot-melt adhesive fibers protruding from the nanofibers. In other words, the hot-melt adhesive fibers ensure that the nanofiber layer is bonded to the substrate layer, and a protective effect against abrasion of the nanofibers is also achieved.

The hot-melt adhesive fibers pass through the nanofiber layer and thereby also contact the substrate layer, thus allowing a connection, in particular a bonded connection, between the nanofiber layer and the substrate layer.

The hot-melt adhesive fibers can be deposited on the nanofibers in a disordered or ordered manner, e.g. in the form of continuous fibers having a mesh structure. The hot-melt adhesive fibers can be connected to the substrate layer at least along length portions. Within the meaning of the invention, adhesive and/or hot-melt adhesive fibers are also understood to be adhesive and/or hot-melt adhesive fibers having a comparatively small length extension or even drops.

According to a preferred embodiment, a weight per unit area of the adhesion promoter layer can be at least 5 times less than a weight per unit area of the adhesive and/or hot-melt adhesive fibers. This achieves an optimal compromise between the pre-fixing effect (adhesive force) and the least possible restriction of the air permeability of the substrate layer caused by the adhesion promoting agent applied over the surface. In a preferred variant, the weight per unit area of the adhesion promoter layer is at least 10 times less than the weight per unit area of the adhesive and/or hot-melt adhesive fibers.

According to a likewise preferred embodiment, the adhesion promoting agent can be an adhesive dispersion having a solids content of 10% to 30%, preferably 15% to 25%.

In one particular embodiment, the adhesion promoting agent can
be an aqueous polyurethane dispersion, in particular having a water content of 70% to 90%, preferably 75% to 85%, and/or a polyurethane content of 10% to 30%, preferably 15% to 25%, and/or
be applied having a weight per unit area of 0.05 g/m² to 1.0 g/m², preferably 0.2 g/m² to 0.6 g/m².

In a further embodiment, the substrate layer is a nonwoven fabric layer which comprises at least 90 wt. % cellulose and/or plastics fibers, the nonwoven fabric layer being a carded web and/or spunlaid web, preferably a spunbonded fabric, and/or melt-blown fabric.

Alternatively or in addition, the substrate layer can comprise bicomponent fibers, in particular having a PP base material, and/or have a weight per unit area between 25 and 125 g/m², preferably between 30 and 90 g/m². The bicomponent fibers can, for example, be in a segmented-pie or islands-in-the-sea configuration. Bicomponent fibers advantageously allow particularly good electrostatic charging of the filter medium.

In a particularly preferred embodiment, the adhesion promoting agent of the adhesion promoter layer can cause sail formation between adjacent fibers in the substrate layer. The formation of sails is well suited for establishing the use of an adhesion promoter layer for (pre-)fixing the nanofiber layer with respect to the substrate layer. The formation of sails is caused by the surface tension of the dispersion medium, in particular when using aqueous adhesive dispersions as adhesion promoting agents.

The surface of the substrate layer that is sealed by the sail formation and is therefore no longer permeable must not exceed a particular limit value, since otherwise the pressure loss of the substrate layer becomes too high. The tendency toward sail formation can be controlled by varying the viscosity parameter of the adhesion promoting agent.

Moreover, the adhesive and/or hot-melt adhesive fibers can be applied at a mass application between 1 and 10 g/m², preferably 4 to 6 g/m².

Moreover, the nanofibers of the nanofiber layer can consist of or comprise a polyamide material, in particular PA6. Alternatively or in addition, the nanofibers can have an average fiber diameter between 50 and 500 nm, preferably between 70 and 150 nm.

This fiber diameter is particularly preferred for filtering particularly fine particles from a medium to be filtered.

According to a further, likewise particularly preferred embodiment, a protective layer can be arranged on the nanofiber layer, which protective layer is connected to the nanofiber layer and the substrate layer by means of the adhesive and/or hot-melt adhesive fibers. The protective layer is a further layer beyond the nanofiber layer and protects the mechanically very sensitive nanofibers from mechanical damage and/or abrasion.

The protective layer can in particular be a particle filtration layer. During production of the filter medium according to the invention, the protective layer can either be arranged on the nanofiber layer after the adhesive and/or hot-melt adhesive fibers have been applied to said nanofiber layer, or can be arranged on the nanofiber layer with the adhesive and/or hot-melt adhesive fibers at the fore after the adhesive and/or hot-melt adhesive fibers have been applied to the protective layer.

In both variants, the adhesive and/or hot-melt adhesive fibers pass through the nanofiber layer, as a result of which the nanofiber layer is connected to the substrate layer and the protective layer is connected to the substrate layer and the nanofiber layer therebetween.

In a further embodiment, the protective layer can be a nonwoven fabric layer which comprises at least 90 wt. % cellulose and/or plastics fibers. In particular, the substrate layer can be a carded web and/or spunlaid web, preferably a spunbonded fabric or melt-blown fabric.

According to a further embodiment, the protective layer can comprise bicomponent fibers, in particular having a PET or PP base material, and/or have a weight per unit area between 15 g/m² and 40 g/m², preferably between 25 g/m² and 30 g/m².

In further embodiments, the filter medium can have at least one further layer adjoining the substrate layer and/or the protective layer. The further layer can preferably be an active material layer and comprise, for example, at least one activated carbon, at least one zeolite and/or at least one ion exchanger material. More than one active material layer can also be provided, with different types of activated carbons, in particular catalytic and/or (alkaline) impregnated activated carbons, being used in particular in separate active material layers.

Alternatively to an embodiment having a protective layer, the filter medium can consist exclusively of the substrate layer, the nanofiber layer, the adhesive and/or hot-melt adhesive fibers and the adhesion promoter layer. Further material layers are not provided in this advantageous embodiment variant, as a result of which good foldability of the filter medium can be ensured, since its thickness is small.

The adhesive and/or hot-melt adhesive fibers can comprise a thermoplastic material or can particularly preferably consist of a thermoplastic material, so that the substrate layer and the nanofiber layer are primarily connected by fusing the fibers.

In particular, the thermoplastic material can be selected from one or more compounds of the following groups: polyolefin, polyester, polyurethane and/or polyamide.

Suitable base polymers for hot-melt adhesives include polyamides (PA), polyethylene (PE), amorphous polyalphaolef ins, ethylene vinyl acetate (co)polymers (EVAC), polyester elastomers (TPE-E), polyurethane elastomers (TPE-U), copolyamide elastomers (TPE-A), and vinylpyrrolidone/vinyl acetate copolymers.

The adhesive and/or hot-melt adhesive fibers can advantageously have a fiber cross-sectional area, i.e. the perpendicular sectional surface through a fiber, which is at least 10 times, preferably at least 15 times, the fiber cross-sectional area of the nanofibers of the nanofiber layer. This allows a wide framework for particularly good mechanical protection.

Alternatively, in the context of the present invention it is also possible to use adhesive fibers, i.e. fibers by means of which bonds can be produced due to their dissolving or melting properties, it being possible for these bonds to be chemically or physically hardening, and/or the aforementioned hot-melt adhesive fibers, i.e. hot-melt adhesives (also called hot melts) in fiber form, the hot-melt adhesive fibers being thermally meltable adhesive systems that develop cohesion (internal strength) through cooling. Hot-melt adhesive fibers can be thermoplastic or reactive. Thermoplastic hot-melt adhesives can be reversibly fused. Reactive hot-melt adhesives display chemical crosslinking reactions during or after cooling.

The adhesive and/or hot-melt adhesive fibers can advantageously have a melting point which is at least 30° C. below the melting point of the nanofibers of the nanofiber layer. As a result, when the hot-melt adhesive fibers are applied in the partially liquefied state, no large-area melting region is formed as a result of simultaneous melting of the nanofibers, which would reduce the filter performance of the nanofiber layer.

The melting point of the hot-melt adhesive fibers is advantageously 200° C. By contrast, the melting point of conventional polyamide nanofibers is 220° C.

To provide a large filtration surface while simultaneously providing adequate protection against mechanical loads, more than 70%, preferably more than 90%, of a surface of the nanofiber layer on the inflow or outflow side of the substrate layer can be not covered by adhesive and/or hot-melt adhesive fibers.

In a further embodiment variant, the hot-melt adhesive fibers can be fused to the substrate layer at least in regions. The nanofibers of the nanofiber layer together with the hot-melt adhesive fibers also have melting points as connection points. In this embodiment, the hot-melt adhesive fibers pass through the nanofiber layer and ensure a particularly advantageous bonding of the nanofiber layer to the carrier, and the protective effect against abrasion of the nanofibers is also achieved.

The nanofibers of the nanofiber layer and the substrate layer can each have connection regions to the adhesive and/or hot-melt adhesive fibers, in which regions an integral bond is produced between the adhesive and/or hot-melt adhesive fibers and the nanofibers of the nanofiber layer or the substrate layer.

According to a first embodiment, the method according to the invention for producing a filter medium comprises the following steps:
A providing a substrate layer;
B applying an adhesion promoting agent over the surface of the substrate layer in order to form an adhesion promoting layer;
C arranging a nanofiber layer on the adhesion promoting layer, thereby fixing the nanofiber layer with respect to the substrate layer;
D arranging adhesive and/or hot-melt adhesive fibers on the nanofiber layer, which adhesive and/or hot-melt adhesive fibers pass through the nanofiber layer, thereby at least forming a connection between the substrate layer and the nanofiber layer.

The adhesive and/or hot-melt adhesive fibers can be arranged on the nanofiber layer in step D either by arranging the adhesive and/or hot-melt adhesive fibers directly on the nanofiber layer or by arranging the adhesive and/or hot-melt adhesive fibers indirectly on the nanofiber layer. “Indirect arrangement” can be understood, for example, to mean that the adhesive and/or hot-melt adhesive fibers are firstly arranged on a further layer of the filter medium, which further layer is then arranged, with its side covered by the adhesive and/or hot-melt adhesive fibers at the fore, on the nanofiber layer so that the adhesive and/or hot-melt adhesive fibers that are still adhesive can pass through the nanofiber layer.

According to a preferred variant of the method, the method can be a discontinuous method, wherein in particular step D is carried out temporally and/or spatially separated from step C, wherein, preferably after step C, the

step C1: winding up a product obtained from step C;

and, before step D, the

step D1: supplying the product wound up in step C1;

is carried out.

This has the advantage that, in the production process according to the invention, the nanofiber layer does not have to be connected to the substrate layer by means of adhesive and/or hot-melt adhesive fibers directly after the nanofiber layer has been arranged/deposited on the substrate layer, as was usually the case in the prior art, but instead the step of the (final) connection of the nanofiber layer to the substrate layer can be spatially and/or temporally separated from the step of arranging/depositing the nanofiber layer on the substrate layer. This is advantageously associated with a significant increase in the flexibility of the production process, since, for example, the production means for arranging the adhesive and/or hot-melt adhesive fibers on the nanofiber layer does not have to be in-line directly downstream of the nanofiber depositing process, but can be provided at another point in a production installation so that this production means can also be used for other purposes.

This is achieved by the nanofiber layer already being fixed or pre-attached with respect to the substrate layer when or shortly after the nanofibers are deposited on the substrate layer by means of the adhesion promoting layer. As a result, production means can be optimally utilized, which can considerably reduce the production costs, since the production means are not permanently integrated into a production infrastructure for the production of the filter medium according to the invention, but can be used elsewhere.

According to a preferred development of the method, the method also comprises the step F: arranging a protective layer on the nanofiber layer, thereby forming a connection between the protective layer, the nanofiber layer and the substrate layer by means of the adhesive and/or hot-melt adhesive fibers.

In a likewise preferred additional development, before the protective layer is arranged on the nanofiber layer, the adhesive and/or hot-melt adhesive fibers can be either

(a) deposited on the nanofiber layer or

(b) deposited on the protective layer, the protective layer being arranged on the nanofiber layer with the adhesive and/or hot-melt adhesive fibers at the fore when being arranged on the nanofiber layer.

In one variant, it is advantageously possible for the adhesion promoting agent to be applied to the substrate layer in step B by means of a roller wetted by the adhesion promoting agent. A particularly small amount of adhesion promoting agent can be applied by roller application, in particular if a low-viscosity adhesive dispersion, preferably in the form of an aqueous adhesive dispersion, is used as the adhesion promoting agent.

A further aspect of the invention relates to the use of the filter medium according to the invention in a filter element, in particular in folded, embossed and/or wound form, in particular in conjunction with a heat engine, an electrochemical device and/or a ventilation device, in particular of a motor vehicle.

In the following, the invention will be explained in greater detail by means of embodiments and with reference to a plurality of drawings.

### BRIEF DESCRIPTION OF THE DRAWINGS

FIG. 1a is a schematic view of a filter medium according to the invention in a first embodiment;

FIG. 1b is a schematic view of a filter medium according to the invention in accordance with the first embodiment, detail A from FIG. 1a;

FIG. 2 is a schematic view of a filter medium according to the invention in a second embodiment;

FIG. 3 is a schematic view of a production process according to the invention;

FIG. 4 is a SEM image of a preliminary product of the filter medium according to the invention with visible sail formation magnified 100 times;

FIG. 5 is a SEM image of a preliminary product of the filter medium according to the invention magnified 1000 times;

FIG. 6 is a SEM image of the filter medium according to the invention magnified 500 times;

FIG. 7 is a SEM image of the filter medium according to the invention magnified 1000 times;

FIG. 8 is a SEM image of the filter medium according to the invention with visible sail formation magnified 100 times;

FIG. 9 is a SEM image of the filter medium according to the invention with visible sail formation magnified 1000 times.

The figures only show examples and are not to be understood as limiting.

### DETAILED DESCRIPTION

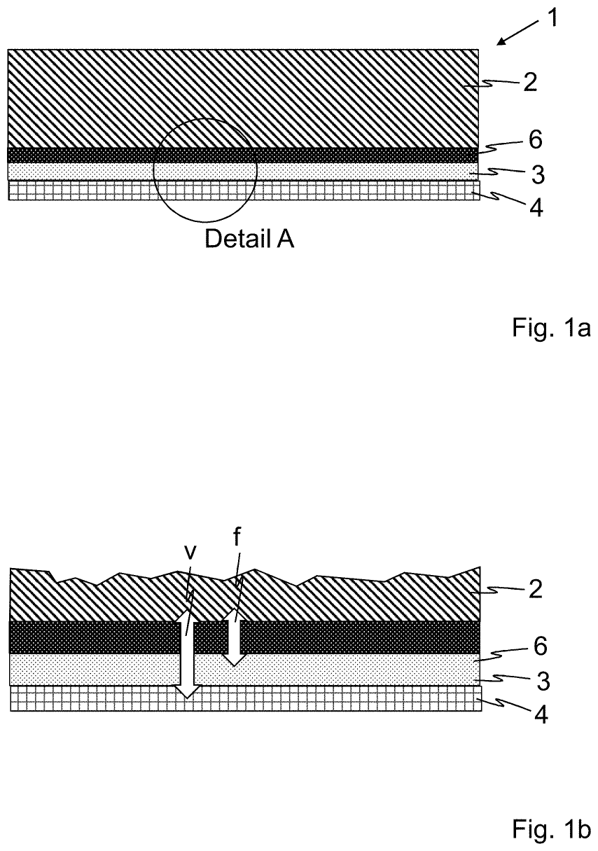

FIG. 1 shows an embodiment of a filter medium 1 according to the invention comprising a substrate layer 2, which is preferably designed as a first fiber layer, and comprising at least one nanofiber layer 3 arranged on the substrate layer on the inflow or outflow side, which nanofiber layer is designed as a second fiber layer.

The substrate layer 2 can preferably be a nonwoven fabric layer and particularly preferably a carded web or spunlaid web, in particular a melt-blown or fabric spunbonded fabric. It preferably comprises fibers having an average fiber diameter of preferably more than 1 μm, in particular between 3 μm and 50 μm.

In a preferred embodiment, the substrate layer 2 can comprise more than 90 wt. % plastics fibers and/or cellulose fibers. The remaining wt. % to make up to 100 wt. % comprises impregnation additives for mechanical and chemical stabilization and binders. In this case, the substrate layer 2 does not need to have an essential filter function, but can mainly be used for the stability of the filter medium, in particular of the further fiber layer arranged thereon, in particular the nanofiber layer 3. According to this embodiment, the substrate layer can also be referred to as a support layer. Alternatively, the substrate layer can also be designed as a pre-filter layer, which in particular filters out coarser particles from the medium flow.

The substrate layer 2 can preferably be designed as a carrier layer for a nanofiber layer 3 arranged adjacent thereto. The individual fibers of the nanofiber layer 3 have an extremely small fiber diameter, and the applied layer is structurally comparable to a fine cobweb. The nanofiber layer 3 has a correspondingly high tendency toward destruction, and this tendency is intended to be counteracted.

The fibers of the nanofiber layer 3 preferably have an average fiber diameter between 50 and 500 nm, preferably between 70 and 150 nm. The average fiber diameter can be determined in accordance with DIN 53811: 1970-07.

The nanofiber layer 3 can, for example, be arranged on the inflow or outflow side of the substrate layer 2. As a result, advantageous stabilization can be achieved by the hot-melt fibers 4.

If the nanofiber layer 3 is on the outflow side of the substrate layer 2, the substrate layer 2 is preferably designed as a filter layer, in particular as a nonwoven fabric layer for filtration. The nanofiber layer 3 is in this case used for fine filtration of the medium. If the nanofiber layer 3 is on the inflow side of the substrate layer 2, the nanofiber layer 3 is used for surface filtration. In this embodiment variant, the substrate layer 2 arranged on the outflow side of the nanofiber layer 3 does not need to have any filtration properties, but can, as described above, be designed as a support layer.

During production of the filter medium 1, an adhesion promoter layer 6 is first applied to the substrate layer 2, with a weight per unit area of the adhesion promoter layer 6 being many times less than a weight per unit area of the adhesive and/or hot-melt adhesive fibers 4, preferably at least 5 times less. The adhesion promoting agent of the adhesion promoter layer 6 is preferably applied during the production process as a low-viscosity adhesive dispersion, preferably as an aqueous polyurethane dispersion, by means of roller application onto the substrate layer 2, since the desired low weights per unit area in the adhesion promoter layer 6 can be optimally achieved in this way.

After the adhesion promoter layer 6 has been applied, the nanofibers of the nanofiber layer 3 are deposited on the adhesion promoter layer 6 which is still adhesive, as a result of which the nanofibers are mechanically (pre-)fixed with respect to the substrate layer 2. After the (pre-)fixing of the nanofiber layer 3 with respect to the substrate layer 2 in the form of the adhesion promoting agent of the adhesion promoter layer 6 has been hardened, the layer composite obtained in this way can be handled without any problems and can be supplied, for example, to a spatially and/or temporally separated process step for applying the adhesive and/or hot-melt adhesive fibers 4 for the (final) connection of the nanofiber layer 3 to the substrate layer 2.

The nanofiber layer 3 and the substrate layer 2 are interconnected by adhesive and/or hot-melt adhesive fibers 4. The adhesive and/or hot-melt adhesive fibers 4 can be formed individually or preferably as a complete fiber layer.

The adhesive and/or hot-melt adhesive fibers 4 are arranged on the nanofiber layer 3 in such a way that they pass through the nanofiber layer 3 and thus establish a mechanically resilient connection between the nanofiber layer 3 and the substrate layer 2 and also provide protection against mechanical damage of the nanofiber layer 3 (grip protection) on the free surface of the nanofiber layer 3.

The adhesive and/or hot-melt adhesive fibers 4 are arranged on the sequence of the substrate and the nanofiber layers 2 and 3 at a mass application between 1 and 10 g/m², preferably 4 to 6 g/m².

The adhesive and/or hot-melt adhesive fibers 4 are arranged on the nanofiber layer 3 by means of a hot-spraying or spraying process after the nanofiber layer 3 has been applied.

The adhesive and/or hot-melt adhesive fibers preferably comprise at least 20 wt. %, preferably more than 65 wt. %, of a thermoplastic material or an adhesive fiber material. This can particularly preferably be a polyolefin, a polyester and/or a polyamide. The average fiber diameter of the adhesive and/or hot-melt adhesive fibers can preferably be 5 μm to 50 μm, particularly preferably between 15 and 30 μm. The remaining mass proportions in wt. % to make up to 100 wt. % comprise in particular fillers such as calcium carbonate.

A fiber material which is partially dissolved, for example by using a solvent-containing adhesive, can be used as an adhesive fiber material, for example. Alternatively or in addition, the adhesive fibers 4 can consist of an adhesive material or can be provided with an adhesive coating.

The arrangement of the adhesive and/or hot-melt adhesive fibers 4 on the surface of the nanofiber layer 3 allows, as the first layer on the inflow side, protection (e.g. grip protection) for the nanofiber layer 3, since the adhesive and/or hot-melt adhesive fibers 4 are significantly more mechanically stable than the fibers of the nanofiber layer 3 as a result of their many times larger diameter.

According to one embodiment, the adhesive and/or hot-melt adhesive fibers 4 are applied directly to the surface of the nanofiber layer 3.

The filter medium 1 comprising the different material layers is foldable and can be designed as a pleated filter.

The filter medium 1 preferably comprises layers of material, specifically the substrate layer 2, the adhesion promoter layer 4, the nanofiber layer 3 and the hot-melt adhesive fibers 4 or the hot-melt fiber layer.

The filter medium 1 according to the invention is particularly suitable for use in room air filters, in particular as a cabin air filter for motor vehicles. However, applications in the field of industrial filters or for filtering the engine intake air of internal combustion engines are also possible.

FIG. 1b, which shows the detail indicated in FIG. 1a, shows the different effect, described above, of the adhesion promoter layer 6 and the adhesive and/or hot-melt adhesive fibers 4 on the fastening of the nanofiber layer 3. While the adhesion promoter layer 6 fixes the nanofiber layer on the surface of the substrate layer 2 at a relatively lower adhesive force than the adhesive and/or hot-melt adhesive fibers 4 (arrow f), the adhesive and/or hot-melt adhesive fibers 4 pass through the nanofiber layer 3 and connect the nanofiber layer 3 to the substrate layer 2 at a relatively greater adhesive force than the adhesion promoter layer 6 (arrow v). At the same time, the adhesive and/or hot-melt adhesive fibers 4 protect the nanofiber layer 3.

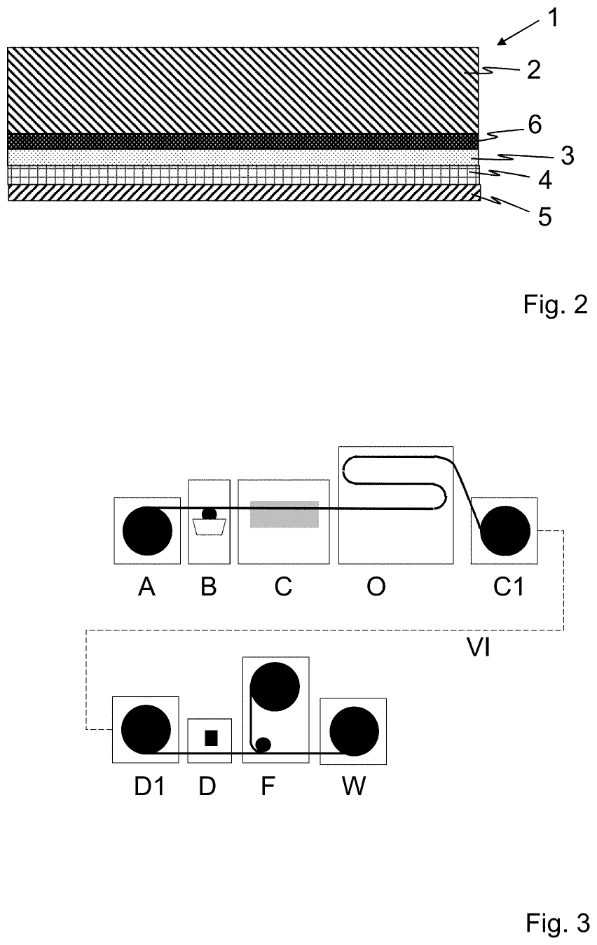

FIG. 2 shows a filter medium 1 according to the invention in a second embodiment. This filter medium comprises a protective layer 5 as an additional layer, which adjoins the adhesive and/or hot-melt adhesive fibers 4 in the sequence of layers. Like the nanofiber layer 3, the protective layer 5 is connected to the substrate layer 2 by means of the adhesive and/or hot-melt adhesive fibers 4, i.e. the adhesive and/or hot-melt adhesive fibers 4 connect both the protective layer 5 to the substrate layer 2 and the nanofiber layer 3 to the substrate layer 2.

According to this embodiment, during the production process it is possible for the adhesive and/or hot-melt adhesive fibers 4 to be deposited directly on the nanofiber layer 3 after the nanofiber layer 3 has been deposited on the substrate layer 2 and then for the protective layer 5 to be arranged on the adhesive and/or hot-melt adhesive fibers 4 that are still adhesive, or for the adhesive and/or hot-melt adhesive fibers 4 to be deposited on a surface of the protective layer 5 before the protective layer 5 is arranged on the layer composite, the protective layer 5 then being arranged, with the adhesive and/or hot-melt adhesive fibers 4 that are still adhesive at the fore, on the nanofiber layer 3 (so-called indirect arrangement of the adhesive and/or hot-melt adhesive fibers 4).

The protective layer is designed as a nonwoven fabric layer which comprises at least 90 wt. % cellulose and/or plastics fibers. The protective layer can in particular be a carded web and/or spunlaid web, preferably a spunbonded fabric or melt-blown fabric.

The protective layer particularly preferably comprises bicomponent fibers, in particular having a PET or PP base material, and/or has a weight per unit area between 15 g/m² and 40 g/m², preferably 25 g/m² to 30 g/m².

Depending on the direction of flow and the desired filtration characteristics, either the substrate layer 2 or the protective layer 5 can assume the main filtration function in the filter medium 1.

FIG. 3 shows a production process diagram for the filter medium 1 according to the second embodiment. The production method for the filter medium 1 according to the first embodiment differs from this second embodiment only in that said first embodiment does not comprise step F.

Firstly, in step A, the substrate layer 2 is provided, in this case in roll form, and supplied to the process, for example by unwinding. The substrate layer 2 is next coated with the adhesion promoting agent in step B in order to obtain the adhesion promoter layer 6, and this takes place as a roller application of a low-viscosity aqueous adhesive dispersion. As long as the adhesion promoter layer 6 is still adhesive, nanofibers for forming the nanofiber layer 3 are deposited on the adhesion promoter layer 6 in step C, in particular by means of an electrospinning process. The adhesion promoter layer 6 in this case provides (pre-)fixation of the nanofiber layer 3 with respect to the substrate layer 2, so that the layer composite obtained can be supplied to downstream process steps. After the application of the nanofibers 3, the layer composite is supplied to a furnace in step O in order to allow the fixing to harden. The layer composite can then be rolled up in step C1, before being processed further. The subsequent process step D1 can be carried out temporally and/or spatially separated, which is symbolized by the dashed line VI.

However, the production method according to the invention can of course also be carried out as a continuous process.

The rolled-up layer composite obtained from step C1 is unrolled again in step D1 and supplied to the application of adhesive and/or hot-melt adhesive fibers 4 in step D, which are in this case deposited directly on the nanofiber layer 3. As long as the adhesive and/or hot-melt adhesive fibers 4 are still adhesive, in step F the layer composite is brought together (laminated) with the protective layer 5, which is unrolled in particular in the form of a web material. The adhesive and/or hot-melt adhesive fibers 4 therefore connect both the nanofiber layer 3 to the substrate layer 2 and the protective layer 5 to the substrate layer 2. At the end of the production process, the layer composite obtained from step F is finally rolled up in step W and can be supplied for processing in order to form folded filter elements, for example.

In a process variant not shown in the figures, the adhesive and/or hot-melt adhesive fibers 4 can be applied to the protective layer 5 in step D, the protective layer 5 then being deposited, with the adhesive and/or hot-melt adhesive fibers 4 at the fore, on the nanofiber layer 3 of the layer composite supplied from step D1.

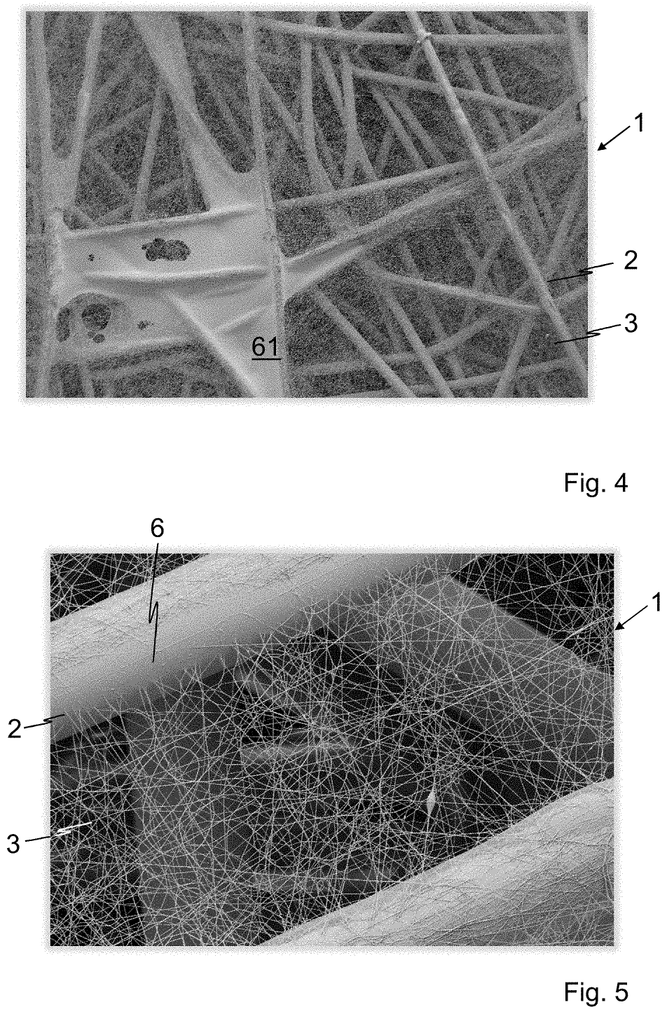

FIG. 4 is an SEM image, magnified 100 times, of a preliminary product of the filter medium 1 according to the invention, with the nanofiber layer 3, which appears as a fine mesh, facing the viewer. The adhesive and/or hot-melt adhesive fibers 4 are not yet present on the preliminary product shown, and therefore (cf. process diagram in FIG. 3) this corresponds to the state after step C or in step D1, i.e. after the nanofibers have been deposited on the adhesion promoter layer 6. FIG. 4 clearly shows sail formation 61 between individual fibers of the substrate layer 2, which is caused by the adhesion promoting agent of the adhesion promoter layer 6. Sail formation 61 of this kind is therefore suitable for establishing the use of (pre-)fixing, by means of an adhesion promoting agent, according to the invention. The sail formation 61 can be observed particularly well when using aqueous adhesive dispersions, due to the surface tension of the water. FIG. 5 shows, magnified 1000 times, the effect of the adhesion promoter layer 6 in terms of fixing the nanofibers 3 to the fibers of the substrate layer 2. It can be clearly seen that the individual fibers of the substrate layer 2 are wetted with adhesion promoting agent 6, so that the nanofibers 3 present as a fine mesh adhere to the fibers of the substrate layer 2.

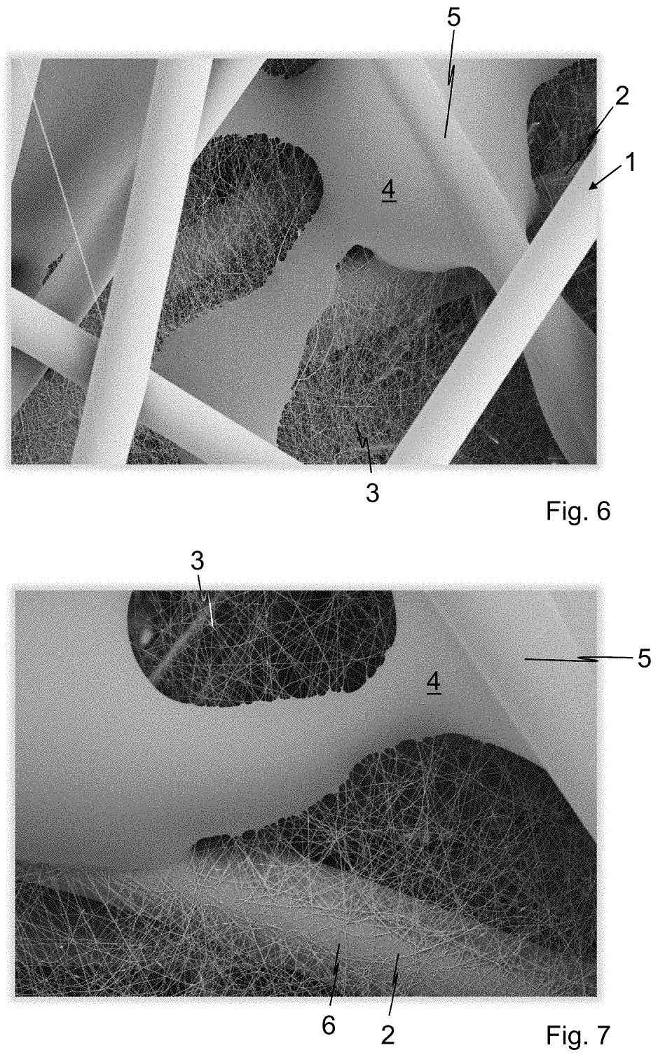

FIG. 6 shows, magnified 500 times, a filter medium 1 according to the second embodiment (comprising the protective layer 5), with the protective layer 5 facing the viewer and behind it, in the corresponding sequence, the adhesive and/or hot-melt adhesive fibers 4, the nanofiber layer 3 (fine mesh) and the substrate layer 2. In particular, it can be seen that the adhesive and/or hot-melt adhesive fibers 4 protrude beyond the nanofiber layer 3 from the image direction and can thereby ensure the mechanical protective function described herein. The adhesive and/or hot-melt adhesive fibers 4 connect both the protective layer 5 to the substrate layer 2 and the nanofiber layer 3 to the substrate layer 2. The fiber of the protective layer 5, shown in the figure at the top right, is in this case completely enclosed by the adhesive and/or hot-melt adhesive fibers 4.

In FIG. 7, which shows the filter medium of FIG. 7 magnified 1000 times, the effect of the adhesion promoter layer 6 can also be seen, specifically in the form of a fixing of the nanofiber layer 3 (fine mesh) to the fiber of the substrate layer 2, shown in the figure at the bottom.

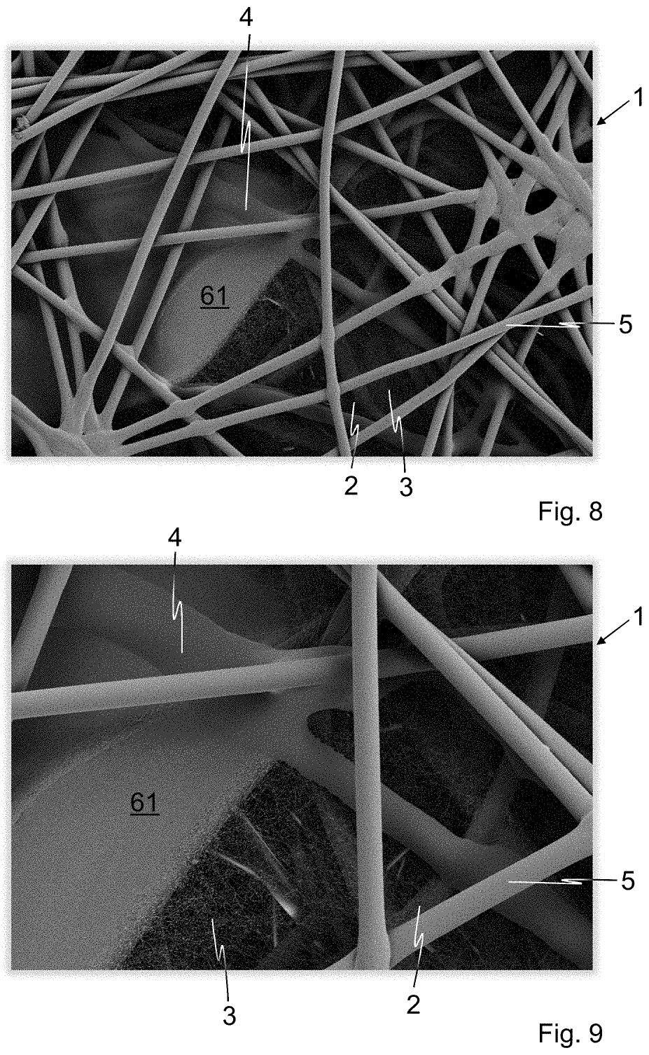

FIGS. 8 and 9 are two further SEM images of the filter medium 1 according to the invention, with the protective layer 5 facing the viewer and behind it, in the corresponding sequence, the adhesive and/or hot-melt adhesive fibers 4, the nanofiber layer 3 (fine mesh) and the substrate layer 2. These images show the sail formation between fibers of the substrate layer 2, which has already been explained in conjunction with FIGS. 4 and 5, which sail formation is suitable as evidence of the (pre-)fixing, according to the invention, of the nanofiber layer 3 with respect to the substrate layer 2.

What is claimed is:

1. A filter medium, comprising:
a substrate layer; and
a nanofiber layer;
wherein the nanofiber layer is attached to the substrate layer by adhesive and/or hot-melt adhesive fibers which pass through the nanofiber layer;
wherein the nanofiber layer is arranged, in a stacked sequence of layers, between the substrate layer and the adhesive and/or hot-melt adhesive fibers;
wherein an adhesion promoter layer is arranged between the nanofiber layer and the substrate layer;
wherein the adhesion promoter layer comprises an adhesion promoting agent applied over a surface of the substrate layer, the nanofiber layer being fixed to the substrate layer by the adhesion promoter layer.

2. The filter medium according to claim 1, wherein
a weight per unit area of the adhesion promoter layer is at least 5 times less than a weight per unit area of the adhesive and/or hot-melt adhesive fibers.

3. The filter medium according to claim 1, wherein
the adhesion promoting agent is an adhesive dispersion having a solids content of 10% to 30%.

4. The filter medium according to claim 1, wherein
the adhesion promoting agent is an aqueous polyurethane dispersion having a water content of 70% to 90%; and/or
wherein the adhesion promoting agent is applied having a weight per unit area of 0.05 g/m² to 1.0 g/m².

5. The filter medium according to claim 1, wherein
the substrate layer is a nonwoven fabric layer which comprises at least 90 wt. % cellulose and/or plastics fibers, the nonwoven fabric layer being a spunbonded fabric, and/or melt-blown fabric.

6. The filter medium according to claim 5, wherein
the substrate layer comprises bicomponent fibers having a PP base material, and/or has a weight per unit area between 25 and 125 g/m².

7. The filter medium according to claim 1, wherein
the adhesion promoting agent of the adhesion promoter layer causes a sail formation between adjacent fibers in the substrate layer.

8. The filter medium according to claim 1, wherein
the adhesive and/or hot-melt adhesive fibers are applied as a mass application between 1 and 10 g/m².

9. The filter medium according to claim 1, wherein
nanofibers of the nanofiber layer consist of or comprise a polyamide material and/or have an average fiber diameter between 50 and 500 nm.

10. The filter medium according to claim 1, wherein
a protective layer is arranged on the nanofiber layer, the protective layer is attached to the nanofiber layer and the substrate layer by the adhesive and/or hot-melt adhesive fibers.

11. The filter medium according to claim 10, wherein
the protective layer is a nonwoven fabric layer which comprises at least 90 wt. % cellulose and/or plastics fibers;
wherein the the protective layer is a carded web and/or spunlaid web or a spunbonded fabric or a melt-blown fabric.

12. The filter medium according to claim 11, wherein
the protective layer comprises bicomponent fibers having a PET or PP base material, and/or has a weight per unit area between 15 g/m² and 40 g/m².

13. The filter medium according to claim 1, wherein
the filter medium consists exclusively of the substrate layer, the nanofiber layer, the adhesive and/or hot-melt adhesive fibers and the adhesion promoter layer.

14. The filter medium according claim 1, wherein
the adhesive and/or hot-melt adhesive fibers comprise or consist of a thermoplastic material, the thermoplastic material selected from one or more compounds of the following groups: polyolefin, polyester, polyurethane and/or polyamide.

15. A method for producing a filter medium according to claim 1, comprising the steps:
A) providing a substrate layer;
B) applying an adhesion promoting agent over the surface of the substrate layer in order to form an adhesion promoting layer,
C) arranging a nanofiber layer on the adhesion promoting layer, fixing the nanofiber layer with respect to the substrate layer;
D) arranging adhesive and/or hot-melt adhesive fibers on the nanofiber layer with the adhesive and/or hot-melt adhesive fibers passing through the nanofiber layer, forming a connection between the substrate layer and the nanofiber layer.

16. The method according to claim 15, wherein
the method is a discontinuous method, and in particular step D is carried out temporally and/or spatially separated from step C;
wherein after step C, the method further includes:
C1) winding up a product obtained from step C; and,
wherein before step D, the method further includes:
supplying the product wound up in step C1, is carried out.

17. The method according to claim 16, wherein the method additionally comprises the step:
F) arranging a protective layer on the nanofiber layer, thereby attaching the protective layer, the nanofiber layer and the substrate layer by means of the adhesive and/or hot-melt adhesive fibers.

18. The method according to claim 17, wherein the adhesive and/or hot-melt adhesive fibers, before the protective layer is arranged on the nanofiber layer, are either deposited on the nanofiber layer or deposited on the protective layer;
wherein the protective layer is arranged on the nanofiber layer with the adhesive and/or hot melt adhesive fibers at the fore when being arranged on the nanofiber layer.

19. The method according to claim 15, wherein
the adhesion promoting agent is applied to the substrate layer in step B by the steps of:
applying the adhesion promoting agent onto a roller;
rolling the adhesion promoting agent onto the substrate layer.

20. A filter element comprising:
the filter medium according to claim 1, the filter medium folded, embossed and/or wound to form the filter element.
